(19) United States
(12) Patent Application Publication
(10) Pub. No.: US 2001/0032081 A1
(43) Pub. Date: Oct. 18, 2001

(54) System for on-demand delivery of user-specific audio content

(75) Inventors: Nicholas K. Unger, Vienna, VA (US); Timothy W. Hall, Fairfax, VA (US); Robert E. Cuthriell, Chevy Chase, MD (US); Joseph M. Saunders, Washington, DC (US)

Correspondence Address: John W. Ryan, WILMER, CUTLER & PICKERING, 2445 M. Street N.W., Washington, DC, 20037-1420, US

(73) Assignee: AudioPoint, Inc.

(21) Appl. No.: 09/739,656

(22) Filed: Dec. 20, 2000

Related U.S. Application Data
(60) Provisional application No. 60/172,571, filed on Dec. 20, 1999.

(51) Int. Cl. G10L 11/00

(52) U.S. Cl. 704/270.1

(57) ABSTRACT

The present invention relates to a system for on-demand user-specific audio content. The system may include a telco interface, a content transformer, and interfaces to data providers. The telco interface may be configured to provide access to users over a public switched telephone network. A user may access the system utilizing a single telephone number, which may be toll-free to provide an easier method of accessing the system. As the system answers a call from a user, the telco interface may be further configured to provide an audio interface for users to interact with to access and to retrieve user-specific audio content from the system. With the audio interface, users may vocally request an item of information. Automated voice recognition units of the telco interface speech process the request into a speech data value, which is forwarded to the content transformer. The content transformer returns the corresponding audio content related to the speech data value, which is then replayed to users.

### BACKGROUND OF THE INVENTION

1. Field of the Invention

The invention relates to the distribution of information content. More particularly, the invention relates to the assembly and delivery of information content in response to a user request by the use of speech recognition techniques, and the delivering of information content in audio format from a remote source using a telephone.

2. Background

The growth of the Internet has coincided with the growth of the availability of information for users of the Internet. With the rapid proliferation of Web sites, a typical user may access information relating to a variety of subject matter such as education, research, news, shopping, opportunities, employment, etc., in virtually real time.

To access the information from the Internet, a typical user requires a desktop computer with access to an Internet Service Provider (“ISP”). An ISP provides access between the users and the Internet. The ISP typically charges a monthly fee for this access which may become prohibitive for some users.

Moreover, since access to the Internet is often tied to a stationary desktop computer, often the user's mobility is limited while accessing the Internet. Recently, portable electronics manufacturers have introduced many products which allow mobile access, i.e., wireless, to the Internet. However, these products are often a separate purchase from the desktop computer requiring additional expenditures. Moreover, the user may also have to purchase a wireless services account from a wireless services provider, which may also become cost prohibitive.

Besides the Internet, other media exist for transmitting information to users. For example, radio and television are media that users often use to obtain information. Radio and television stations transmit their programming over the electromagnetic spectrum. The range of the radio and television stations is typically dictated by the strength of their signals. The loss of a radio or television station is a viable possibility for a mobile user who may move out of the range of radio or television station.

Moreover, a typical user may not customize the type of information received from a radio and/or television station. Radio/television stations are programmed by station managers, which is often dictated by sponsors and popularity. Accordingly, a user may be forced to wait till a radio/television station transmits, if ever, the relevant desired information. This waiting may be an inconvenience for the user.

There are also information providers that provide users with relevant real-time information. For instance, many local telephone services provide a telephone number in which a caller may call for the local forecast, traffic conditions or the like. However, this type of service is limited to a specific geographic area and this service only offers fixed types of information.

Some information providers even provide telephonic information services where a user may dial a single number to access a variety types of information. Once a user calls a designated number, the user is prompted by audio cues for navigating the telephonic information service. For a given audio cue, the user is typically given choices from available information services each corresponding to one or more keys of the keypad of the telephone. Accordingly, the user navigates through the telephonic information service by using the keypad of the telephone.

Although this type of telephone information service does provide useful information, the use of the keypad limits the usefulness of these telephonic information services. For instance, if a user desires information that is several layers within the menu of the telephonic information service, the user has to listen through the several layers of the menu to retrieve the one desired item of information. Accordingly, a user may spend more time than necessary utilizing the telephonic information services.

Alternatively, a user may memorize the keypad sequence of navigation to retrieve an item of relevant information to overcome the wait of navigating a several-layered menu. However, this solution forces users to memorize key-press sequences on the keypad. Although this solution is reasonable for one or two items of information, it becomes more problematic as the items of information increases and as the layers of menu on the telephonic information service increases.

Moreover, as users become increasingly mobile, users may still utilize a telephonic information system in order to retrieve information while driving. As a user is navigating the menu structure of the telephonic information system, the user may be forced to take his eyes off the road, thus, becoming a hazard to himself and to others.

### SUMMARY OF THE INVENTION

In accordance with the principles of the present invention, a method of delivering audio content to a user. The method includes requesting an audio query by the user over a telephone, and translating the audio query into a database query for requesting the audio content from an audio content provider. The method further includes transmitting an audio response of the database query to the user over the telephone.

One aspect of the present invention is a method of delivering audio content to a user. The method includes receiving a vocal request at an audio interface of an audio content provider from the user where the audio interface configured to convert said vocal request into an electronic query. The method also includes retrieving a requested audio content from the audio content provider by the audio interface is in response to the electronic query. The method further includes outputting the requested audio content by the audio interface where the audio interface is further configured to output the requested audio content to said user over a public switched telephone network.

Another aspect of the present invention is a method of browsing a network, where the method includes receiving a vocal browsing request at an audio interface of a content provider from a user. The method includes converting the vocal browsing request to a text browsing request by the audio interface, and searching the network by a wireless application interface configured to search the network according to the text browsing request. The method further includes outputting by the audio interface at least one search result from the wireless application interface in response to the text browsing request.

Yet another aspect of the present invention is a voice portal for delivering on-demand audio content to a user. The voice portal includes a telco interface configured to interface a network, a content transformer configured to provide retrieval of information to the telco interface, and an audio interface configured to speech process a vocal request received through the telco interface from the user over the network to retrieve a request for audio content from the content transformer.

Yet another aspect of the present invention is a voice portal for delivering on-demand audio content to a user. The voice portal includes a wireless application interface configured to interface a wireless network and a content transformer configured to provide retrieval of information to the wireless application interface. The voice portal also includes a wireless application server configured to process a request received through the wireless application interface from a mobile user over the wireless network to retrieve a request for audio content from the content transformer.

Yet another aspect of the present invention is a voice portal for delivering on-demand audio content to a user, where the voice portal includes a telco interface configured to interface a network, and a wireless application interface configured to interface a wireless network. The voice portal further includes a content transformer configured to provide retrieval of information for both the telco interface and the wireless application interface. The voice portal also includes a wireless application server configured to process a request for audio content received through one of the telco interface and the wireless application interface to retrieve the request for audio content from the content transformer and to transmit retrieved audio content to the other of the telco interface and the wireless application interface.

### BRIEF DESCRIPTION OF THE DRAWINGS

Features and advantages of the present invention will become apparent to those skilled in the art from the following description with reference to the drawings, in which:

FIG. 1 illustrates a block diagram of an embodiment of a voice portal according to the principles of the present invention;

FIG. 2 illustrates a more detailed block diagram of an embodiment of a telco interface of the voice portal shown in FIG. 1;

FIG. 3 illustrates a more detailed block diagram of an embodiment of a content transformer of the voice portal shown in FIG. 1;

FIGS. 4a-4c illustrates a flow diagram of an embodiment of an audio interface for the voice portal shown in FIG. 1;

FIGS. 5a-5b illustrates a flow diagram of an embodiment of a recognition error processing for the audio interface of the voice portal;

FIGS. 6a-6b illustrates a flow diagram of an embodiment of a profile submenu for the audio interface of the voice portal;

FIGS. 7a-7c illustrates a flow diagram of an embodiment of a business submenu for the audio interface of the voice portal;

FIGS. 8a-8b illustrates a flow diagram of an embodiment of an invalid submenu selection processing module for the audio interface of the voice portal;

FIG. 9 illustrates a block diagram of an embodiment implementing a wireless application protocol service to the voice portal;

FIG. 10 illustrates a block diagram of an embodiment implementing a business connection service to the voice portal; and

FIGS. 11a-11b illustrates a flow diagram of an embodiment of an attendant processing service for the voice portal.

### DETAILED DESCRIPTION OF ILLUSTRATIVE EMBODIMENTS

The present invention relates to a system for on-demand user-specific audio content. The system may include a telco interface, a content transformer, and interfaces to data providers. The telco interface may be configured to provide users an access to the system over a public switched telephone network. A user may access the system utilizing a single telephone number, which may be toll-free to provide an easier method of accessing the system. As the system answers a call from a user, the telco interface may be further configured to provide an interactive audio interface for users to access and to retrieve user-specific audio content from the system. With the audio interface, users may vocally request an item of information. Automated voice recognition units of the telco interface speech process the request into a speech data value, which is forwarded to the content transformer. The content transformer returns the corresponding audio content related to the speech data value, which is then replayed to users.

Unlike prior art systems that require a user traverse each level of a menu, the inventive audio interface of the system may provide an option to hear the available audio content and/or may provide a second option for a user to directly retrieve a desired item of audio content. A user may directly request a desired item of information by vocalizing the item of information. The vocal request is captured by the automated speech recognition units of the telco interface when prompted by the audio interface of the system. The automated speech recognition units may be further configured to apply speech or voice recognition algorithms on the captured speech utterance. The speech recognition algorithms return an electronic value or speech data value, which can be verified by the audio interface of the system as a valid item of information.

The speech data value may be then passed by a local area network interface of the telco interface to the content transformer. Upon receipt of the electronic value of the speech utterance, the content transformer may be configured to retrieve a data value associated with the electronic value of the speech utterance. The content transformer may be further configured to packetize the data value, and to return packetized data value to the telco interface.

Upon receipt of the packetized data value, the telco interface may be further configured to apply data-to-speech algorithms to transform the data value into speech that is heard by the user if the requested item of information is in text data format. Otherwise, the telco interface may replay the retrieved item of information. Accordingly, by using speech recognition techniques, a user is provided with the capability of navigating the system without the use of the keypad of the user's telephone. The safety and convenience of the user while driving is greatly improved. Moreover, since a user may vocally select a menu item without hearing all menu items, a user is not required to memorize keypad sequences to retrieve a desired item of information.

The system may be further configured to provide for a standby attendant. The standby attendant may provide for the capability of uninterrupted service in the event that the speech recognition algorithms is not able to convert a speech utterance of a user into a speech data value. The standby attendant may listen to a speech utterance of a user simultaneously as the speech recognition algorithms of the telco interface process the speech utterance. If the telco interface is unable to process the speech utterance, the standby operator may send the respective data value to the content transformer. Accordingly, a user may be provided with seamless and uninterrupted operation.

The system may be further configured to include a profile of a user to customize the audio content for automated retrieval. A user may be provided the capability to set up a profile of preferred of items of information that a user would like to hear when using the system. The profile may be set up through an Internet interface of the system. Once the profile is activated by the system, a user may be given the items of information that the user desires in response to the user logging into the system. Accordingly, a user may be given user-specific audio content on demand without waiting for menu options to be played.

The system may be yet further configured to include a capability for a user to retrieve a telephone of a partnered business or to be connected to the partnered business directly or to the partnered business' representative. A user may call into the system, and upon hearing of an interested partnered business, the user may vocalize the name of the partnered business and be connected through the system via a public switched telephone network to the partnered business or its representative. Alternatively, a user may be afforded the capability to hear a telephone number of a selected partnered business in response to vocalizing the name of the selected partnered business. Accordingly, a user may be given toll-free and convenient access to a number of business in partnership with the system, thus providing a user with a convenient and inexpensive service.

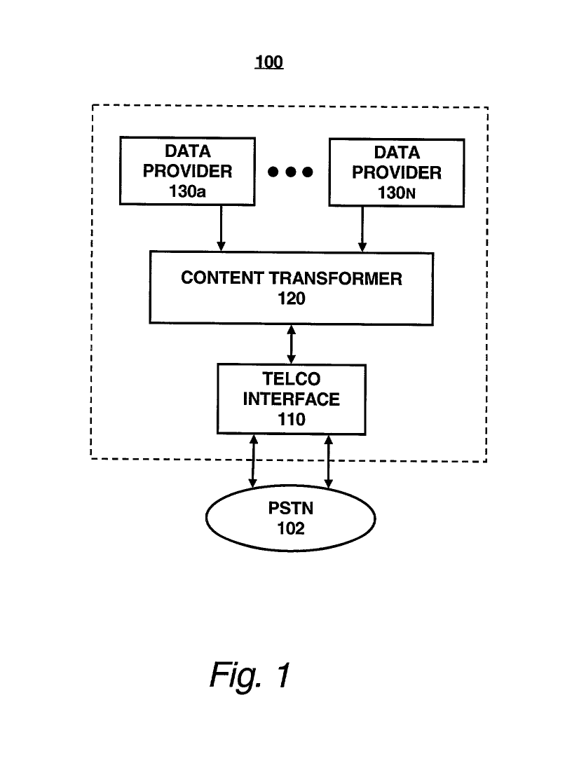

FIG. 1 illustrates a block diagram of an exemplary embodiment of the voice portal 100 according to the principles of the present invention. In particular, the voice portal 100 includes a telco interface 110, a content transformer 120, data providers 130a . . . 130n. The telco interface 110 may be configured to provide an interface between the voice portal 100 and a public switched telephone network (“PSTN”) 102. A user may access the voice portal 100 by dialing a single telephone number over the PSTN 102. The telephone number may be a toll-free number, thus providing cost-free access to the voice portal 100. Alternatively, a number of telephones numbers, each local to a given geographical area could also be provided to provide lowest-cost access to the voice portal 100.

The telco interface 110 may be further configured to apply automated speech or voice recognition algorithms on speech utterances of a user along with an audio interface for a user or caller to navigate the voice portal 100. The speech recognition algorithms of the telco interface 110 may output a corresponding speech data value for the speech utterance. The audio interface of the voice portal 100 may be configured to verify that the speech data value is a valid selection for the voice portal 100. The telco interface may be further configured to packetize the speech data value, and to send the packetized data value to the content transformer 120.

The content transformer 120 may be configured to retrieve a corresponding audio content in response to the receipt of the data value from the telco interface 110. The content transformer 120 may be further configured to packetize the corresponding audio content for delivery to the telco interface 110. The telco interface 110 may be further configured to transmit the received audio content from the content transformer 120 to a user.

The content transformer 120 may be further configured to interface with data providers 130a . . . 130n. The interface may include a T1 interface between the content transformer 120 and the respective data providers 130a . . . 130n. However, other interfaces such as X.25, digital subscriber line, Internet, local area network, etc., are also contemplated by the present invention.

The data providers 130a . . . 130n may be configured to provide content to the content transformer 120. The content may be audio, digital audio or text data. Moreover, the data providers may a variety of providers providing information from financial, weather, sports, television, news, etc. For example, data provider 130 may be configured to provide traffic updates for a given geographic area.

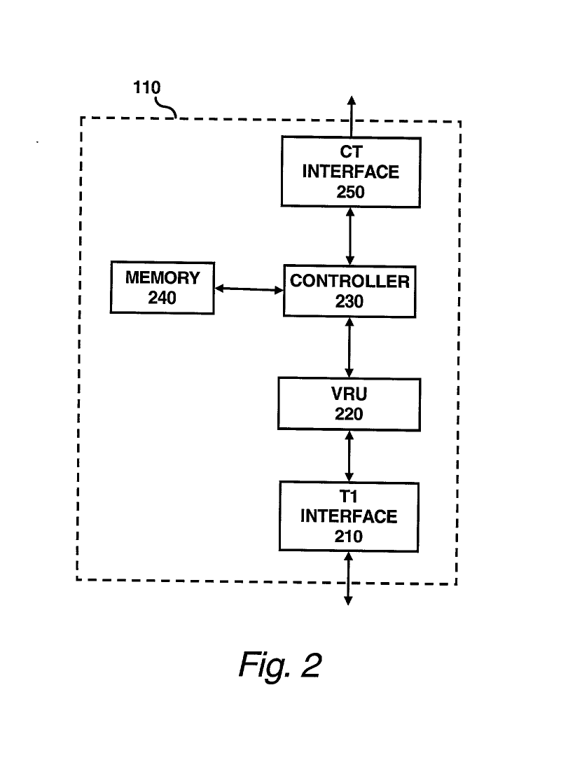

FIG. 2 illustrates a more detailed block diagram of an embodiment of the telco interface 110 shown in FIG. 1. As shown in FIG. 2, the telco interface 110 may include a T1 interface 210, a voice recognition unit (“VRU”) 220, a controller 230, a memory 240, and a content transformer (“CT”) interface 250. The T1 interface 210 may be configured to interface with the PSTN 102 of FIG. 1 * through a T1 line. The T1 interface 210 may provide simultaneous access for up to twenty-four different users.

The T1 interface 210 may be configured to interface with the VRU 220. The VRU 220 may be configured to record speech utterances of a user of the voice portable 100 and to apply automated speech or voice recognition algorithms on the recorded speech utterances of a user of the voice portal 100. The VRU 220 may be further configured to transfer the output of the speech recognition algorithms on the recorded speech utterances to the controller 230.

The VRU 220 may be further configured to receive requested audio content from the content transformer 120 and transmit the received audio content to a caller. The audio content may include pre-recorded audio content or the audio content may include textual data. In the event of receiving textual data, the VRU 220 may be further configured to apply speech synthesis algorithms on the received textual data to convert the textual data to audio data for playback to the caller.

The VRU 220 may be further configured to interface with the controller 230. The controller 230 may be configured to provide an execution platform for an application software that provides the functionality of the VRU 220 and for the audio interface. The controller 230 may be a microprocessor, a micro-controller, a digital signal processor or the like.

The controller 230 may be further configured to packetize the output of the speech recognition algorithms the content transformer through the CT interface 250. The controller 230 may be further configured to receive content from the content transformer 120 and de-packetize the received content for the VRU 220.

The controller 230 may also be configured to be interfaced with a memory 240. The memory 240 may be configured to store the application software for execution by the controller 230. The controller 230 may be further configured to be interfaced with the content transformer interface 250. The content transformer interface 250 may be configured to transmit and receive message packets between the content transformer 120 and the telco interface 110.

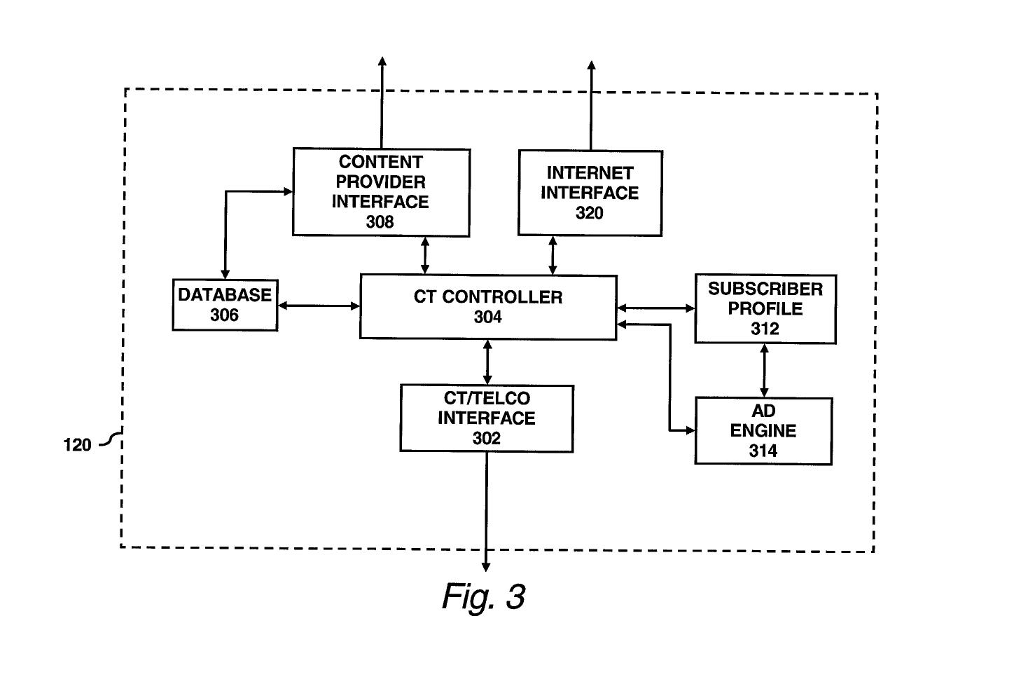

FIG. 3 illustrates a more detailed block diagram of an exemplary embodiment of a content transformer 120 of the voice portal shown in FIG. 1. In particular, the content transformer 120 includes a CT/telco interface 302 configured to provide an interface for the exchange of data packets between the content transformer 120 and the telco interface 110. The CT/telco interface 302 may be further configured to interface with a CT controller 304. The CT controller 304 may be configured to provide an execution platform for an application software that provides the functionality of the content transformer 120. The CT controller 304 may be implemented with a microprocessor, a microcontroller, a digital signal processor or the like.

The CT controller 304 may be also configured to interface with a database 306. The database 306 provides storage and retrieval of items of information for, the voice portal 100. The database 306 may be implemented using a RAID-array of disks, a single large disk or the like. Some items of information stored on the database 306 may be periodically updated through a content provider interface 308, which may also be configured to interface with the CT controller 304. Data content providers may send updates to the content transformer 120 where the CT controller 304 would use the updates to refresh the content in the database 306. Alternatively, the data providers may by-pass the CT controller 304. Instead, data providers may send their updates to database directly through the content provider interface 308.

The content transformer 120 may further comprise a subscriber profile database 312, which may be configured to give an automated delivery of pre-selected information whenever a subscriber calls into the voice portal 100. The subscriber profile may be created by accessing the voice portal 100 through an Internet interface 320. A computer-based user may then create a subscriber profile through a web site of the voice portal 100, which is then stored in the subscriber profile database 312. When a user calls in and activates the user's subscriber profile, items of information requested during the creation the subscriber profile are delivered to the user.

Alternatively, the subscriber profile of a user may be created passively by tracking the usage of the user through the voice portal 100. The controller 230 may maintain a database of the types of information requested by the usage along with the frequency. From the pattern of usage, a subscriber profile for the user may be created indexed by the automatic number identification and/or caller identification information of the user.

The subscriber profile database 312 may also be utilized by an advertisement engine 314. The advertisement engine 314 may be configured to provide relevant advertisements of businesses partnered with the voice portal according the subscriber profile. In this manner, a user is not inundated with irrelevant and/or unwanted advertisements.

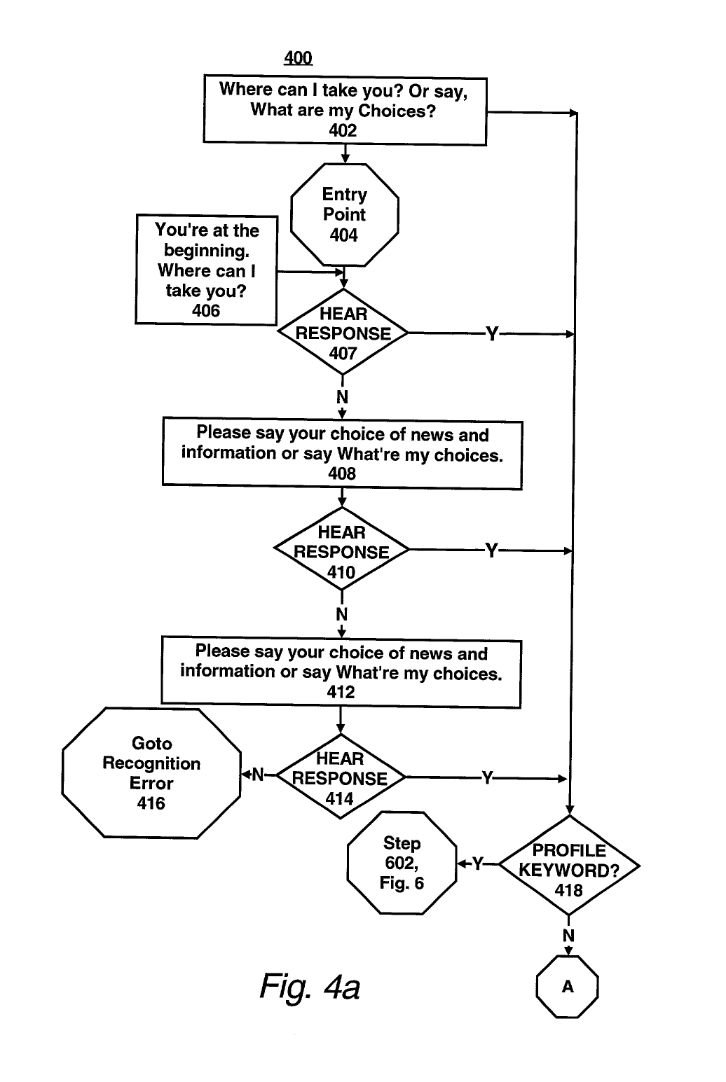

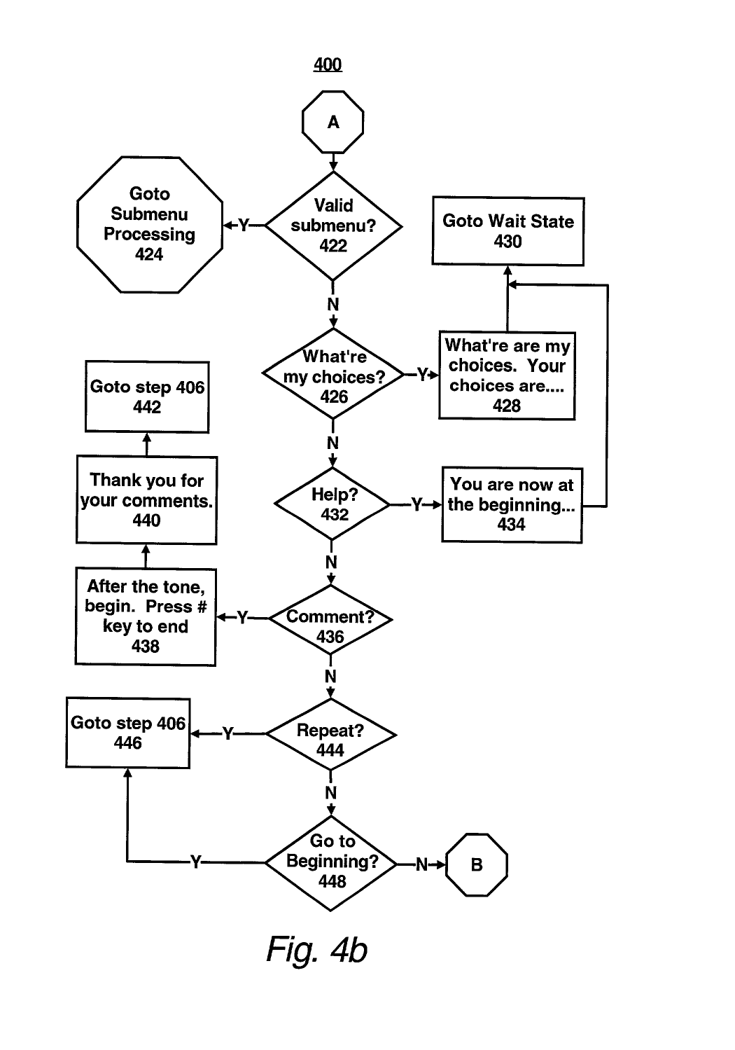

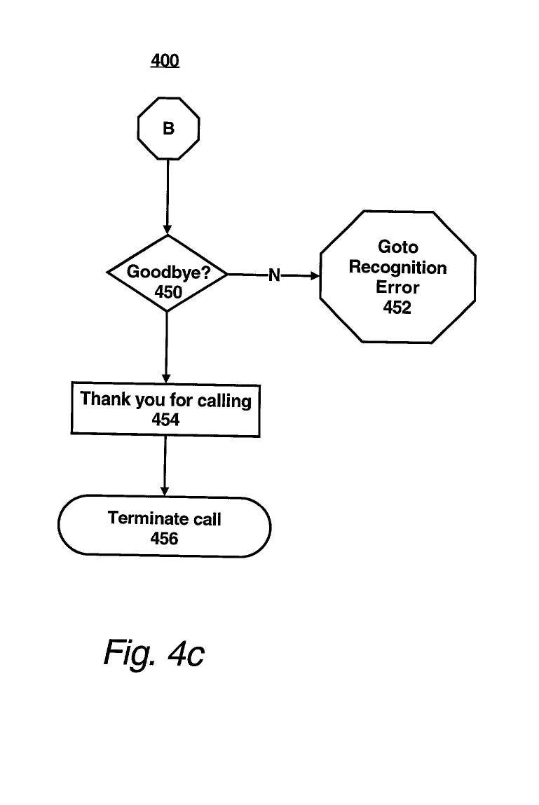

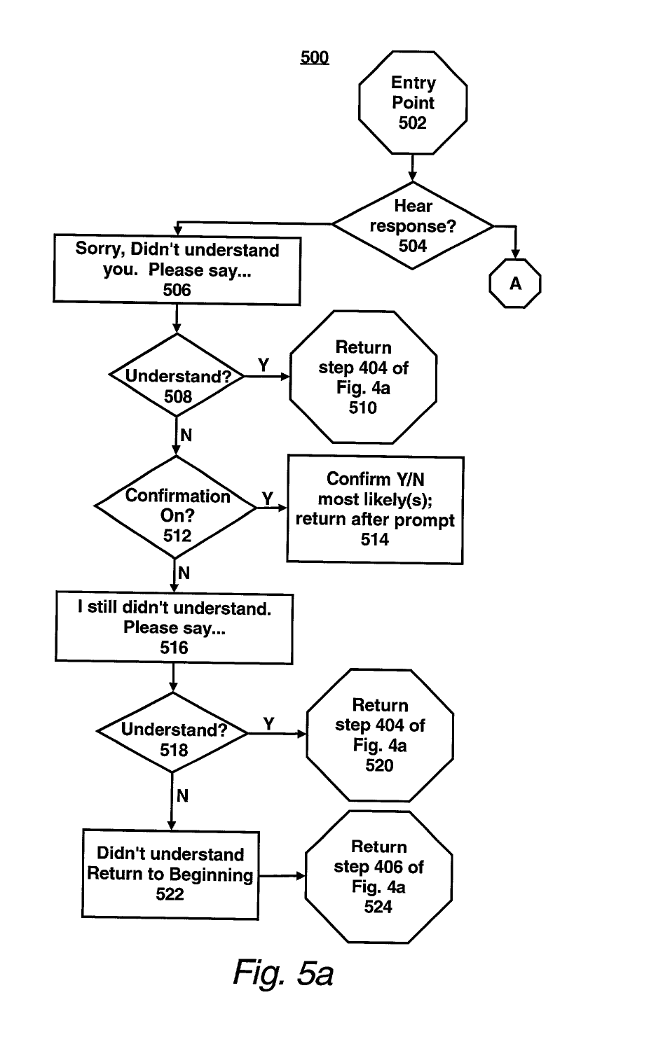

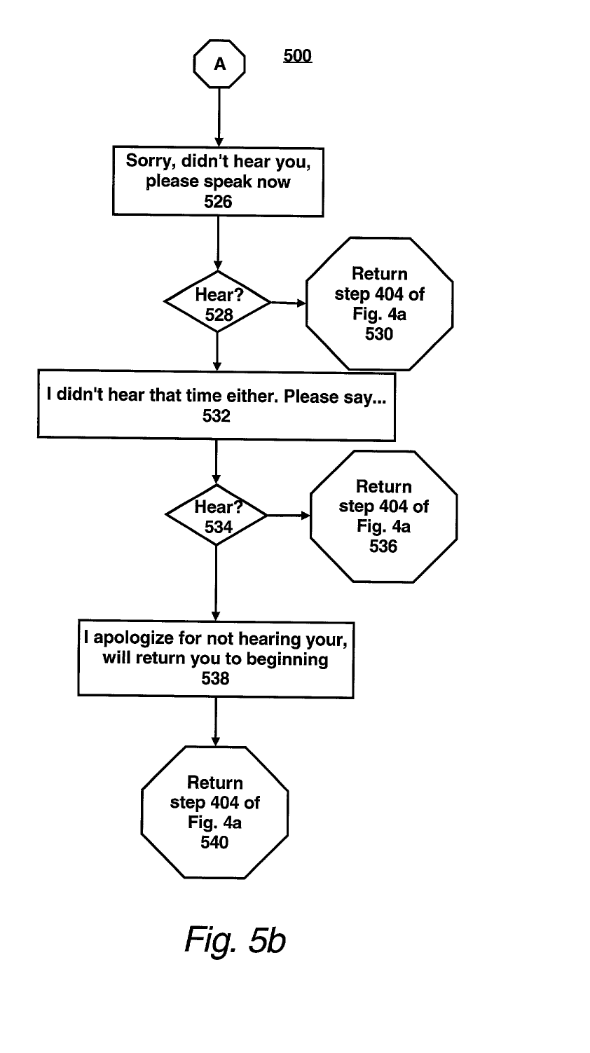

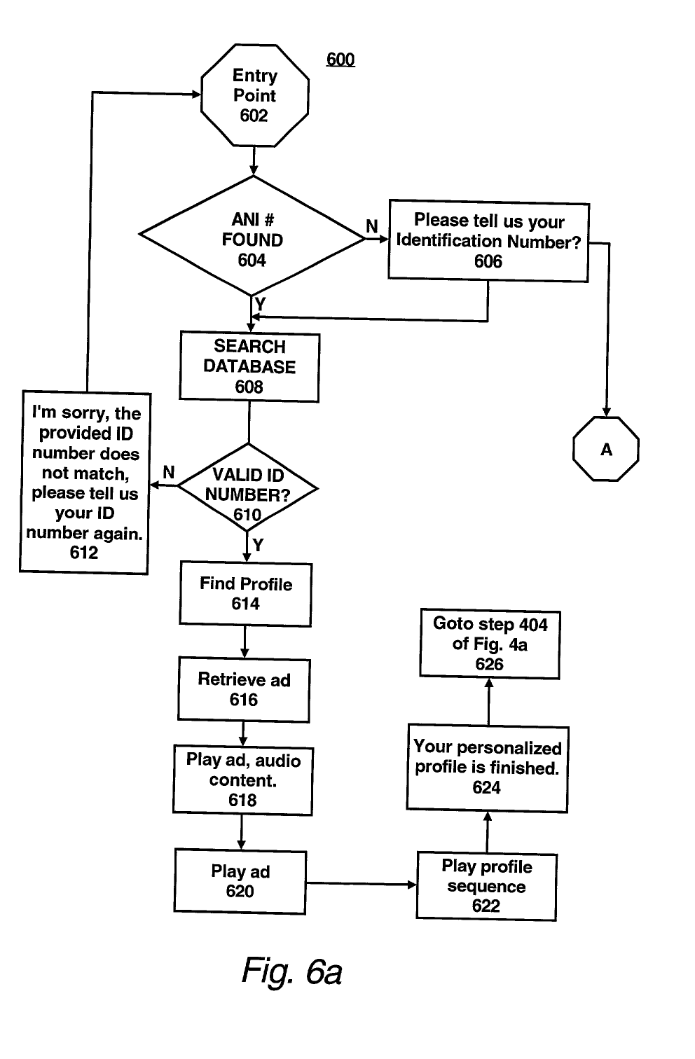

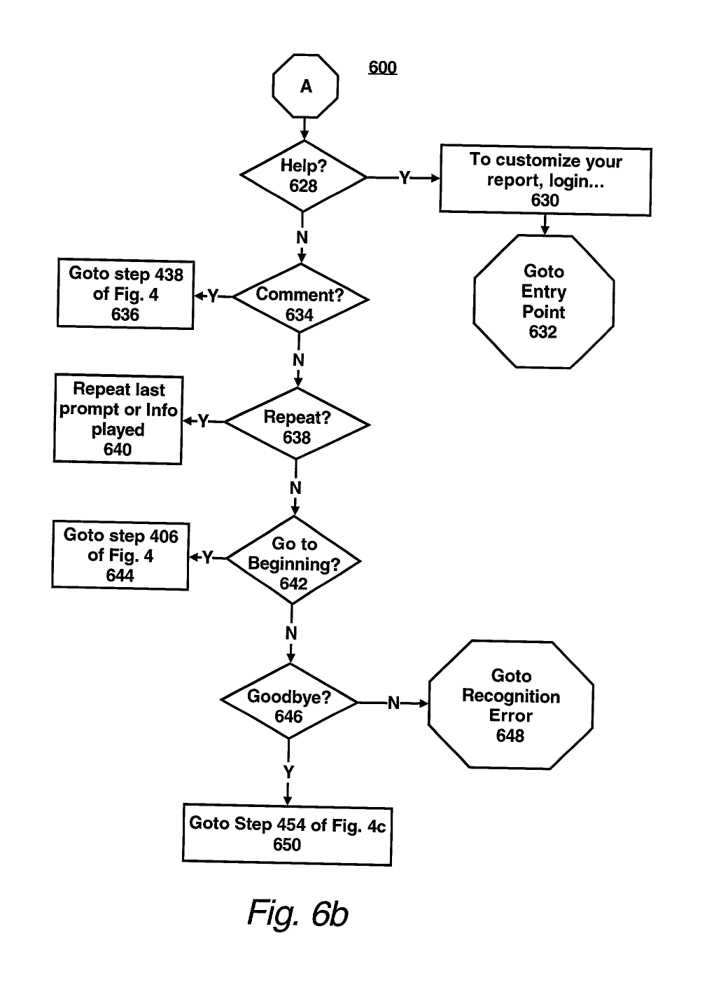

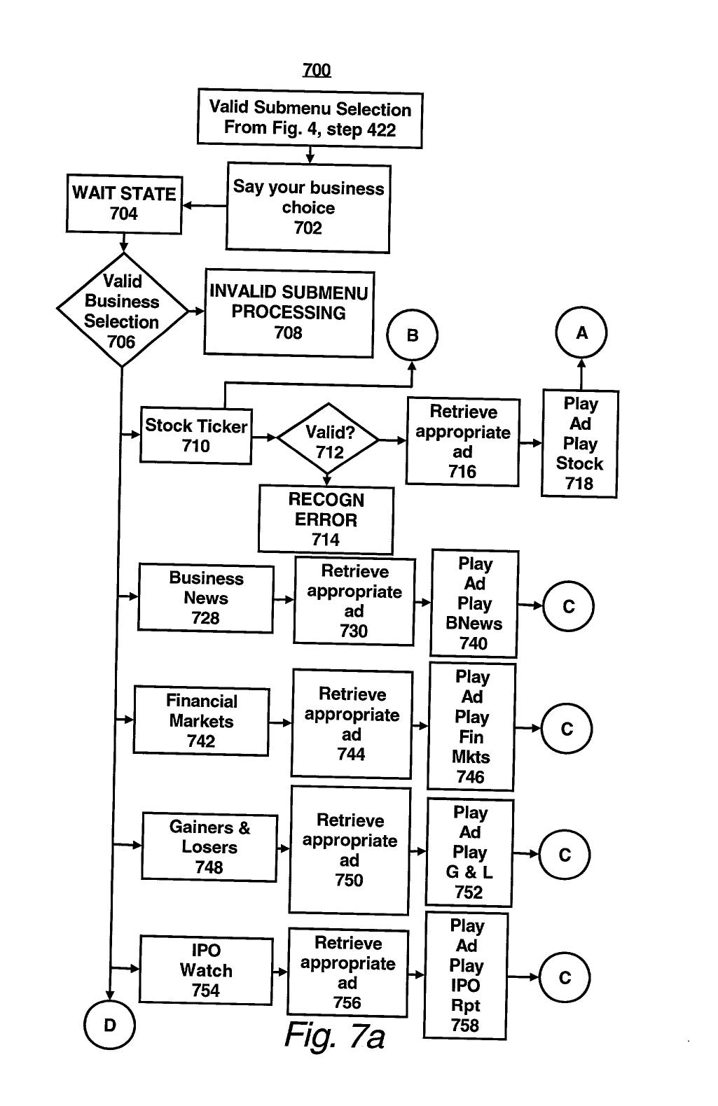

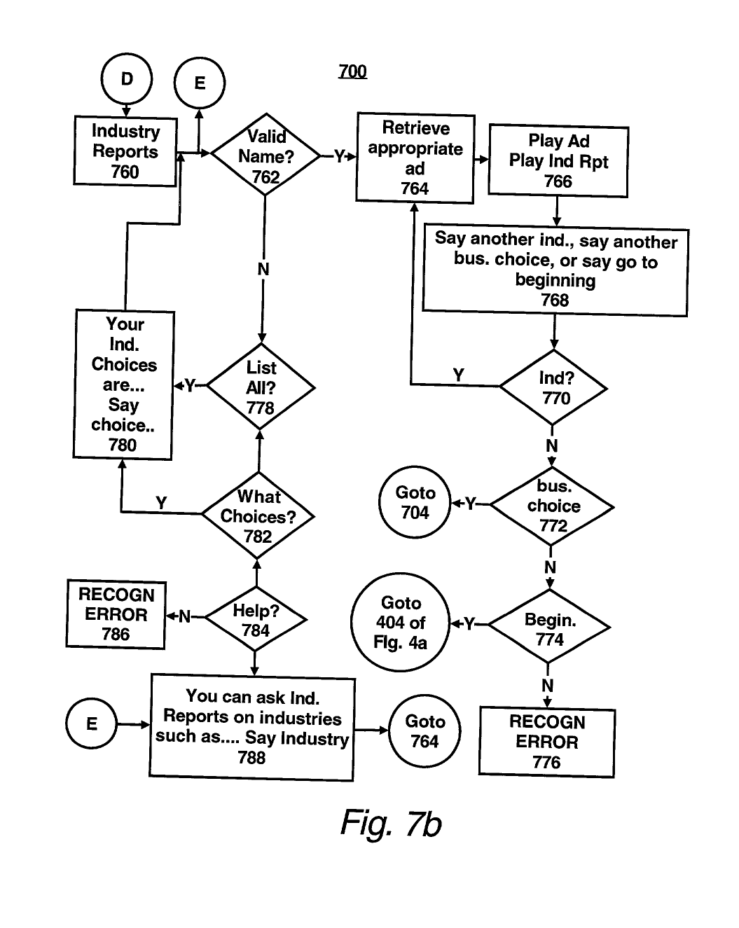

FIGS. 4a-4c illustrate an exemplary embodiment of a flow diagram 400 of a main menu of an audio interface of the voice portal 100 according to the principles of the present invention. In particular, with reference to FIG. 4a, the controller 230 of the voice portal 100 may be configured to provide an audio interface to prompt a user or caller with a greeting message of inquiring what type of information the user is seeking or if the user would like to hear a list of available options of types of information that is available, in step 402. However, in the event that a user has a pre-determined type of information such as a business submenu, a sports submenu, a traffic submenu, a weather submenu, a news submenu, an entertainment submenu, a profile submenu, a flight information submenu, etc., a user may be taken to the selected type of information in response to a vocalization of the selected type, in step 422, as shown in FIG. 4b. Otherwise, the audio interface of the voice portal 100 is then directed to step 404, which is an entry point for the audio interface to return after providing information content to a user. Besides step 404, step 406 is another return entry point for the audio interface to return. In step 406, a user is prompted with an audio cue informing the user that the audio interface of the voice portal 100 has returned to the beginning.

In step 407, the audio interface of the voice portal 100 waits for a period of time, e.g., three seconds, for the user to respond with a speech utterance or vocal input. If the period of time has elapsed, the controller 230 directs the audio interface of the voice portal 100 to prompt the user to state a choice of types of information or if the user would like to hear a list of available choices of types of information, in step 408.

In step 410, the voice portal 100 waits for another period of time, e.g., three seconds, for the user to respond with a speech utterance or audio input. If the period of time has elapsed, the controller 230 directs the audio interface of the voice portal 100 to prompt the user to state a choice of type of information or if the user would like to hear a list of available choices of types of information, in step 412.

In step 414, the audio interface of the voice portal 100 waits for yet another period of time, e.g., three seconds, for the user to respond with a speech utterance. If the user fails to responds within the period of time, the audio interface of the voice portal 100 is directed by the controller 230 to proceed to a recognition error processing as shown in FIG. 5, which is described in detail below. Otherwise, if the audio interface of the voice portal 100 detects a response from a user, in step 414, step 410 or step 407, the VRU 220 of the voice portal 100 determines whether if the user had uttered a profile keyword, e.g., “profile”, in step 418.

If the detected speech response from the user is the profile keyword, the audio interface is directed by the controller 230 to a profile submenu of the audio interface of FIG. 6, which is discussed in detail below.

On the other hand, if the detected speech response is determined not to be the profile keyword, but a valid submenu selection, the audio interface may be directed by the controller 230 to a submenu processing in step 424, as shown in FIG. 4b. The audio interface of the voice portal may be organized by categories of information. These categories may include business, sports, traffic, weather, news, entertainment, horoscope, profile, and flight information.

Else if the detected speech is not a valid submenu selection, but a request for a listing of available choices of the voice portal 100, the audio interface may be directed by the controller 230 to step 426. In step 426, the audio interface may be directed by the controller 230 to play an audio cue for the user listing the available choices of information maintained by the voice portal 100, in step 428. The audio interface of the voice portal 100 then proceeds to step 404 of FIG. 4a to wait for a response from the user, in step 430.

Else if the detected speech processed by the VRU 220 is a request for assistance, e.g., “HELP”, in step 432, the audio interface may be directed by the controller 230 to play an audio cue for the user explaining the location of the user in the audio interface and/or the possible options available for the user, in step 434. The audio interface of the voice portal 100 then proceeds to step 404 of FIG. 4a to wait for a response from the user, in step 430.

Else if the detected speech processed by the VRU 220 is a request to record a comment for the service provider of the voice portal 100, e.g., “COMMENT”, in step 436, the audio interface may be directed by the controller 230 to prompt a pre-recorded message to instruct a user to leave a message, in step 438. When the user completes the message, the audio interface prompts the user with an audio cue thanking the user for leaving a message, in step 440. The audio interface is then directed to step 406 of FIG. 4a to wait for a response from the user.

Else if the detected speech processed by VRU 220 is a request a repeat of an audio prompt, e.g., “REPEAT”, from either step 407 or 410 or 414, in step 444, the audio interface may be directed by the controller 230 to proceed to step 406 of FIG. 4a, in step 446.

Else if the detected speech processed by VRU 220 is a request to restart the audio interface, e.g., “GO TO BEGINNING”, from either step 407 or 410 or 414, in step 448, the audio interface may be directed by the controller 230 to go to step 406 of FIG. 4a, in step 446.

Else, with reference to FIG. 4c, if the detected speech processed by VRU 220 is a request to logout or exit the voice portal 100, e.g., “GOODBYE”, from either step 407 or 410 or 414, in step 450, the audio interface may be directed by the controller 230 to prompt the user with a logout or goodbye message, in step 454. The audio interface then terminates the call from the user, in step 456.

Else if the detected speech processed by VRU 220 is not within the vocabulary of the VRU 220, the controller 230 of the voice portal 100 directs the audio interface to proceed to the recognition error processing shown in FIGS. 5a and 5b, which is described in detail below.

FIG. 5 illustrates a flow diagram of an exemplary embodiment of the recognition error processing 500. The recognition error processing may be referenced when the audio interface cannot process a vocal input from a user. As shown in FIG. 5a, if the vocal input has been detected by the audio interface of the voice portal 100, in step 504, the audio interface is directed by the controller 230 to prompt the user with an audio cue indicating inability to process the speech utterance and to request the user to repeat the speech utterance in step 506.

If the speech utterance of the user is able to be processed by the VRU 220 of the voice portal 100 in step 508, the audio interface is directed by the controller 230 to proceed to step 404 of FIG. 4a in step 510. Otherwise, if the repeated speech utterance of the user is still unable to be processed by the VRU 220 of the voice portal 100 in step 508, the controller 230 of voice portal 100 determines whether or not a confirmation option was previously set by the user in step 512.

If the confirmation option is set, the audio interface is directed by the controller to provide a list of utterances that may have been uttered by the user. The user is asked to confirm with a yes or no response after a replay of each utterance in step 514. The audio interface is either taken to the location of a positive response, i.e., the interface menu corresponding to the positively confirmed utterance, or returned to step 404 of FIG. 4a.

If the confirmation option is not set from step 512, the audio interface is directed by the controller 230 to prompt the user with an audio cue explaining that it was unable to process the speech utterance and to repeat the speech utterance in step 516.

If the VRU 220 is able to speech process the speech utterance, the audio interface is directed by the controller 230 to step 404 of FIG. 4a. Otherwise, the audio interface of the voice portal 100 prompts the user with an audio cue that it was unable to process the speech utterance and is returning to the beginning of the audio interface in step 522. The audio interface is then directed to step 406 of FIG. 4a, as discussed herein above. Alternatively, if the VRU 220 cannot output a data value for the repeated speech utterance from step 522, the audio interface of the voice portal 100 informs the user that it was unable to process the repeated speech utterance, and the audio interface returns the user to the beginning of the particular layer of menu prompt where the speech recognition problem occurred.

If in step 504, there was no response from the user, the controller 230 directs the audio interface to prompt the user with an audio cue explaining that the voice portal 100 is unable to hear the response of the user and to please repeat the response, in step 526 with reference to FIG. 5b.

If the VRU 220 of the voice portal 100 is able to detect a response, the audio interface is directed by the controller 230 to return to step 404 of FIG. 4a, in step 530. Otherwise, the controller 230 directs the audio interface to prompt a user with an audio cue explaining that the voice portal 100 is unable to hear the response of the user and to please repeat the response in step 532.

If the VRU 220 of the voice portal 100 is able to detect a response, the audio interface is directed by the controller 230 to return to step 404 of FIG. 4a, in step 536. Otherwise, the controller 230 directs the audio interface to prompt a user with an audio cue explaining that the voice portal 100 is unable to hear the response of the user and is returning the user to the beginning, in step 538. The audio interface is then directed to step 404 of FIG. 4a.

FIGS. 6a and 6b illustrate a flow diagram 600 of an exemplary embodiment of a profile submenu processing. The audio interface reference the profile submenu processing when a user utters a profile keyword, e.g., “PROFILE”, at a prompt. As shown in FIG. 6a, once the profile keyword has been uttered, the audio interface is directed by the controller to enter profile submenu processing, in step 602. The controller 230 of the voice portal determines whether the Automatic Number Identification (“ANI”) # and/or caller ID number is found, in step 604. The ANI may be the calling party's telephone number provided by the PSTN 102 or a telecommunication network.

If the ANI # and/or caller ID number was not found, the audio interface of the voice portal 100 prompts the user with an audio cue that is configured to request an identification number such as a telephone number of a user, in step 606. If the user utters an identification number in step 606, the audio interface is directed by the controller 230 to proceed to validate the identification number in a database in step 608. Otherwise, if the ANI # and/or caller ID number was found in step 604, the controller 230 initiates a search of the database of the voice portal 100 to determine whether or not the identification number is valid in step 608.

If the identification number is valid from step 610, the controller 230 of the voice portal 100 accesses the profile of the user in step 614, and retrieves an appropriate advertisement or sponsorship message for the user in step 616. The audio interface of the voice portal 100 may be configured to play the advertisement message for the user along with a lead-in prompt with the audio content determined from the profile of the user in step 618.

After the audio content is finished in step 618, the audio interface may cue another additional advertisement message to the user in step 620. Then, the audio interface replays the information that the user has pre-selected in the subscriber profile of the user in step 622. After the pre-selected information is played in step 622, the audio interface of the voice portal 100 prompts the user that the personalized audio content of the user is finished in step 624. The audio interface then returns to the beginning of the start menu, step 404 of FIG. 4a.

Returning to step 610, if the identification number is not valid, the audio interface of the voice portal 100 prompts the user that the provided identification number does not match the user's previously given identification number, e.g., a registered telephone number in step 612. The audio interface prompts the user to repeat the identification number and returns to step 602.

Returning to step 606, the audio interface of the voice portal 100 may be configured to respond to a user response that does not include an identification number.

With reference to FIG. 6b, if the detected speech response processed by the VRU 220 is a request for assistance, e.g., “HELP”, from step 606, in step 628, the audio interface may be directed by the controller 230 to play an audio cue for the user explaining the function of the profile submenu, in step 630. The audio interface of the voice portal 100 then proceeds to step 602 of FIG. 6a to wait for a response from the user, in step 632.

Else if the detected speech response processed by the VRU 220 is a request to record a comment for the service provider of the voice portal 100, e.g., “COMMENT”, from step 606, in step 436, the audio interface may be directed by the controller 230 to proceed to step 438 of FIG. 4, in step 636.

Else if the VRU 220 speech processes the response from the user is a request a repeat of an audio prompt, e.g., “REPEAT”, from step 606, in step 638, the audio interface may be directed by the controller 230 to replay the last prompt or last item of information in step 640.

Else if the VRU 220 speech processes the response from the user is a request to restart the audio interface, e.g., “GO TO BEGINNING” from step 606, in step 642, the audio interface may be directed by the controller 230 to go to step 406 in step 644.

Else if the detected speech response processed by the VRU 220 is a request to logout or exit the voice portal 100, e.g., “GOODBYE”, from step 606, in step 646, the audio interface may be directed by the controller 230 to proceed to step 454 of FIG. 4.

Else if the VRU 220 is unable to process the response from the user, the controller 230 of the voice portal directs the audio interface to proceed to the recognition error processing shown in FIGS. 5a and 5b, in step 648.

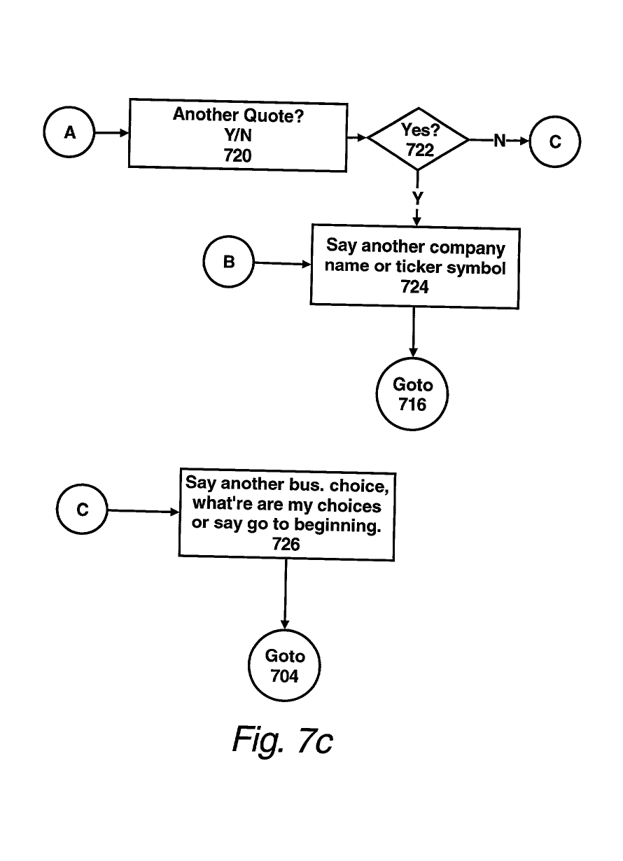

FIGS. 7a-7c illustrate an exemplary embodiment of a flow diagram 700 for a business submenu of the audio interface of the voice portal 100, according to the principles of the present invention. In particular, in step 702, the audio interface of the voice portal 100 prompts the user to vocalize a choice of audio content from at least one category of business in response to a user vocalizing a speech utterance requesting the business submenu from step 422 of FIG. 4b. The categories of business may include stock information, business news, financial markets, industry reports, reports of gainers or losers, etc.

With reference to FIG. 7a, in step 704, the audio interface of the voice portal 100 enters a wait state, awaiting a response from the user. If the VRU 220 of the voice portal detects a speech utterance from the user, VRU 220 applies its speech recognition algorithms on the speech utterance and a speech data value is outputted. The speech data value is compared against the list of categories, or submenus, of information in the business category, in step 706.

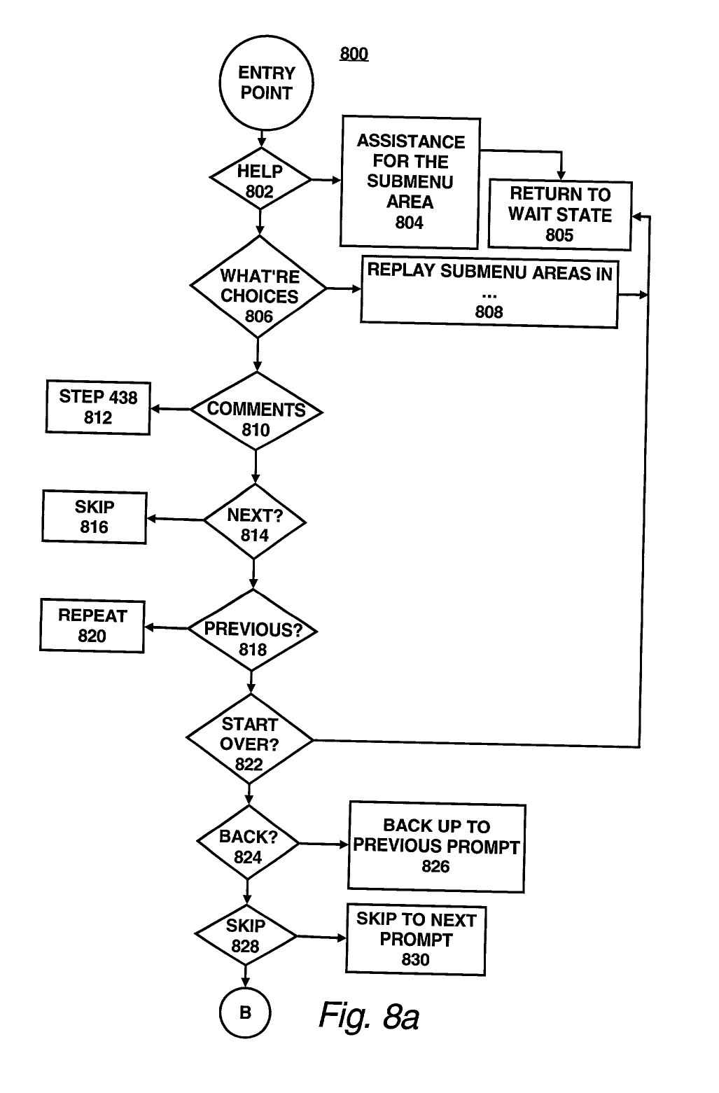

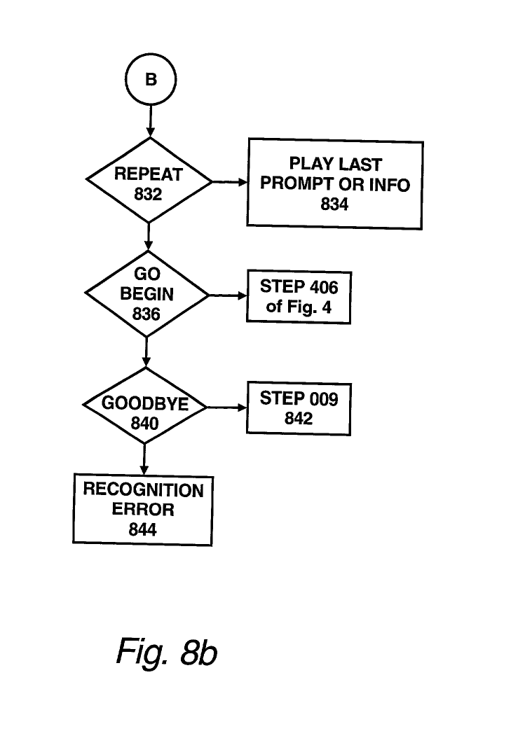

If the user, from step 706, did not utter a valid submenu selection, but enters an invalid submenu selection processing module of the audio interface, in step 708, the controller 230 directs the audio interface to the invalid submenu processing module, which is illustrated in FIGS. 8a and 8b. The invalid submenu selection processing module may be called by other categories of submenus to process an invalid or non-existent menu selection.

If the VRU 220 of the voice portal 100, from step 706, speech processes an audible request from a user to hear stock quote of a company, e.g., “TICKER”, or the company's name, in step 710, the VRU 220 speech processes the request and the controller 230 verifies whether or not the audible request is a valid request, in step 712.

If, from step 712, the controller 230 determines that the audible request for the company name is invalid, the controller 230 directs the audio interface of the voice portal 100 to the recognition error processing module shown in FIGS. 5a and 5b, as described herein above. Otherwise, the controller 230 determines that the audible request for the stock quote of the requested company is valid, the controller 230 retrieves an appropriate advertisement message and stock quote from the content transformer 250, in step 716.

The audio interface of the voice portal 100 replays the retrieved advertisement message for the user followed by the retrieved stock quote, in step 718. With reference to FIG. 7c, the controller 230 directs the audio interface of the voice portal 100 to prompt the user if the user would like another quote with a yes or no response in step 720.

If, in step 722, the VRU 220 of the voice portal 100 speech processes a positive response, e.g., a “YES”, the controller 230 of the voice portal 100 directs the audio interface to prompt the user with an audio cue requesting the user to vocalize another company, in step 724, and the audio interface is then directed to step 716 of FIG. 7a. Otherwise, if the VRU 220 of the voice portal 100 speech processes a negative response, e.g., a “NO”, from step 722, the controller 230 of the voice portal 100 directs the audio interface to prompt the user to Vocalize either another business choice, list of selections, or to restart the audio interface from the beginning, in step 726. The controller 230 then directs the audio interface to return to step 704 to wait for a user vocal response.

Returning to FIG. 7a, if the VRU 220 of the voice portal 100, from step 706, speech processes an audible request from a user to hear the audio content related to business news, in step 728, the controller 230 retrieves an appropriate advertisement message and the requested audio content from the content transformer 250, in step 730. The audio interface of the voice portal 100 replays the retrieved advertisement message for the user followed by the retrieved audio content, in step 740. The controller 230 of the voice portal 100 directs the audio interface to prompt the user to vocalize either another business choice, list of selections, or to restart the audio interface from the beginning, in step 726. The controller 230 then directs the audio interface to return to step 704 to wait for a user vocal response.

If the VRU 220 of the voice portal 100, from step 706, speech processes an audible request from a user to hear the audio content related to financial markets, in step 742, the controller 230 retrieves an appropriate advertisement message and the requested audio content from the content transformer 250, in step 744. The audio interface of the voice portal 100 replays the retrieved advertisement message for the user followed by the retrieved audio content, in step 746. The controller 230 of the voice portal 100 directs the audio interface to prompt the user to vocalize either another business choice, list of selections, or to restart the audio interface from the beginning, in step 726 of FIG. 7c. The controller 230 then directs the audio interface to return to step 704 of FIG. 7a to wait for a user vocal response.

If the VRU 220 of the voice portal 100, from step 706, speech processes an audible request from a user to hear the audio content related to gainers and losers, in step 748, the controller 230 retrieves an appropriate advertisement message and the requested audio content from the content transformer 250, in step 750. The audio interface of the voice portal 100 replays the retrieved advertisement message for the user followed by the retrieved audio content, in step 752. The controller 230 of the voice portal 100 directs the audio interface to prompt the user to vocalize either another business choice, list of selections, or to restart the audio interface from the beginning, in step 726 of FIG. 7c. The controller 230 then directs the audio interface to return to step 704 of FIG. 7a to wait for a user vocal response.

If the VRU 220 of the voice portal 100, from step 706, speech processes an audible request from a user to hear the audio content related to initial public offerings (“IPO”) of companies, in step 754, the controller 230 retrieves an appropriate advertisement message and the requested audio content from the content transformer 250, in step 756. The audio interface of the voice portal 100 replays the retrieved advertisement message for the user followed by the retrieved audio content, in step 758. The controller 230 of the voice portal 100 directs the audio interface to prompt the user to vocalize either another business choice, list of selections, or to restart the audio interface from the beginning, in step 726 of FIG. 7c. The controller 230 then directs the audio interface to return to step 704 of FIG. 7a, to wait for a user vocal response.

With reference to FIG. 7b, if the VRU 220 of the voice portal 100 speech processes a request for reports about an industry maintained by the voice portal 100, in step 760, the controller 230 verifies that the request is a valid request, in step 762. If industry report name is valid from step 762, the controller 230 retrieves an appropriate advertisement message and the requested audio content from the content transformer 250, in step 764. The audio interface of the voice portal 100 replays the retrieved advertisement message for the user followed by the retrieved audio content, in step 766. The controller 230 of the voice portal 100 directs the audio interface to prompt the user to vocalize either another industry choice, another business choice, or to restart the audio interface from the beginning, in step 768.

If the VRU 220 of the voice portal 100 a request for another industry report in step 770, the audio interface is directed by the controller 230 to proceed to step 764.

If the VRU 220 of the voice portal 100 a request for a listing of business choices, in step 722, the audio interface is directed by the controller 230 to step 704.

If the VRU 220 of the voice portal 100 a request to go to the beginning of the audio interface, the audio interface is directed by the controller 230 to go to step 404 of FIG. 4a, and as previously described herein above.

If the VRU 220 of the voice portal cannot by the speech recognition techniques, process the response of the user in step 784, the controller 230 directs the audio interface to proceed to recognition error processing shown in FIG. 5, in step 786.

Returning to step 762, if the industry report name is not valid, the VRU 220 of the voice portal 100 may speech processes a request from a user listing of the selection in this category of information, in step 778, the controller 230 of the voice portal directs the audio interface to provide an audio cue listing the available selections in this category in step 780. The controller 230 then directs the audio interface to step 762.

Else if the VRU 220 of the voice portal 100 speech processes a request from a user listing what are selections or choices available to a user, in step 782, the controller 230 of the voice portal 100 directs the audio interface to step 780.

Else if the VRU 220 of the voice portal 100 speech processes a request from a user requesting assistance in this category, in step 784, the controller 230 directs the audio interface to provide an audio cue to the user explaining possible actions for the user to perform in step 788. Then, the audio interface is directed by the controller 230 to proceed to step 764. Otherwise, from step 762, the controller 230 directs the audio interface to enter the recognition error processing module shown in FIGS. 5a and 5b.

The audio interface of the voice portal 100 may be further configured to provide processing of a group of commands after most prompts. The group of commands may include ‘HELP’, ‘WHAT ARE MY CHOICES’, ‘COMMENT’, ‘NEXT’, ‘PREVIOUS’, ‘MAIN MENU’, ‘START OVER’, ‘BACK’, ‘SKIP’, ‘REPEAT’, ‘GO TO BEGINNING’, ‘GOODBYE’, etc.

The exemplary embodiment of the flow diagram for the business submenu shown in FIGS. 7a-7c may be applied to other categories of audio content that user may be interested in constructing an audio interface thereof. The other categories may include traffic, weather, sports, news, entertainment, flight information, etc.

FIGS. 8a and 8b illustrate a more detailed flow diagram of an embodiment of an invalid submenu selection processing as shown in FIGS. 7a-7c. The invalid submenu selection processing may be invoked by any submenu within the audio interface. As shown in FIG. 8a, if the VRU 220 of the voice portal 100 speech processes a request for assistance, e.g., speech utterance of “HELP”, in step 802, the audio interface of the voice portal 100 prompts the user with an audio cue informing the user of the selections with reference to the calling submenu category and to ask the user to vocalize another response, in step 804. The audio interface is then directed to the wait state of the calling submenu, e.g., step 704 of the business submenu shown in FIG. 7a, in step 805.

If the VRU 220 of the voice portal 100 speech processes an audible request to replay an audible list of business category selections, in step 806, the audio interface of the voice portal 100 replays the list of audible list of business category selection in step 808. The audio interface is then directed to return to the wait state of the calling submenu, in step 805.

If the VRU 220 of the voice portal 100 speech processes an audible request to leave a comment, in step 810, the audio interface of the voice portal is directed to step 438 of FIG. 4b, in step 812.

If the VRU 220 of the voice portal 100 speech processes an audible request to move to the next item in the audio interface, in step 814, the audio interface is directed to the replay the next available audio prompt for the user in the calling submenu, in step 816.

If the VRU 220 of the voice portal 100 speech processes an audible request to replay the most recently played menu item, in step 818, the audio interface of the voice portal 100 is directed to play the last played audio prompt or the most recent delivered audio content requested by the user, in step 820.

If the VRU 220 of the voice portal 100 speech processes an audible request from a user to direct the audio interface to start at the beginning of the main menu, e.g., “START OVER”, in step 822, the audio interface of the voice portal 100 is directed to the wait state of the invoking submenu, e.g., step 404 of FIG. 4a.

If the VRU 220 of the voice portal 100 speech processes an audible request from a user to back up to a previous prompt, e.g., “PREVIOUS”, in step 824, the audio interface of the voice portal 100 backs up to the previous prompt and replays an audio cue informing the user of the previous prompt, in step 826.

If the VRU 220 of the voice portal 100 speech processes an audible request from a user to skip to a next prompt, e.g., “NEXT”, in step 828, the audio interface of the voice portal 100 is directed by the controller 230 to the next prompt of the calling submenu and replays an audio cue informing the user of the next prompt, in step 830.

If the VRU 220 of the voice portal 100 speech processes an audible request from a user to repeat the most recent prompt, e.g., “REPEAT”, in step 832, the audio interface of the voice portal 100 is directed by the controller 230 to the most recent prompt of the calling submenu and replays an audio cue informing the user of the most recent prompt, in step 834.

If the VRU 220 of the voice portal 100 speech processes an audible request from a user to direct the audio interface to go the beginning of the main menu, e.g., “GO BEGINNING”, in step 836 the audio interface of the voice portal 100 is directed by the controller 230 to step 406 of FIG. 4a, in step 838.

If the VRU 220 of the voice portal 100 speech processes an audible request from a user to log out of the voice portal 100, e.g., “GOODBYE”, in step 840, the audio interface of the voice portal 100 is directed by the controller 230 to go to step 464 of FIG. 4b to terminate the call, in step 842.

If the VRU 220 of the voice portal 100 in unable to speech process an audible request from a user, the controller 230 of the voice portal 100 directs the audio interface to enter the recognition error processing module shown in FIGS. 5a and 5b.

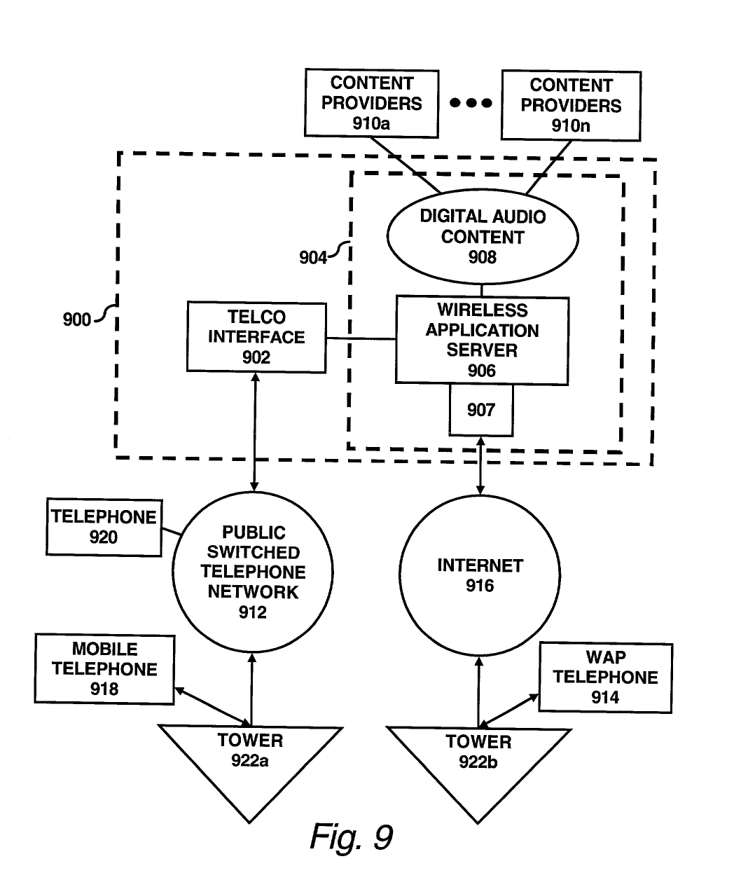

FIG. 9 illustrates an embodiment of a voice portal 900 with the added functionality of a wireless application server interface according to the principles of the present invention. In particular, the voice portal 900 includes a telco interface 902, a content transformer 904, a wireless application server 906, a digital audio content database 908, and content providers 910a . . . 910n. The telco interface 902 may be configured similarly to the telco interface 110 of FIGS. 1 and 2, i.e., include the components and functionality of the telco interface 110, as described herein above.

The content transformer 904 may be also be configured to include the components and functionality of the content transformer 120 shown in FIGS. 1 and 3. Moreover, the content transformer 120 may include the wireless application server 906 may be configured to retrieve a corresponding audio content from the digital audio content database 908, in response to the receipt of the speech data value from the telco interface 902, where the digital audio content database 908 may be configured to provide storage and access to audio content provided by the voice portal 900. The digital audio content database 908 may be further configured to interface with data providers 910a . . . 910n. The interface may include a T1 interface between the content transformer 904 and the respective data providers 910a . . . 910n. However, other interfaces such as X.25, digital subscriber line, Internet, local area network, etc., are also contemplated by the present invention.

The wireless application server 906 may be further configured to send digital audio content to mobile users through a wireless application interface 907 of the wireless application server 906. The wireless application interface 907 may be configured to transmit and receive data/command(s) from wireless application enabled portable electronic devices. The wire application server 906 may be further configured to communicate with wireless application enabled portable electronic devices, utilizing a wireless application protocol, the FLEX™ protocol or other wireless data protocols.

As an example, a user with a WAP-enabled mobile telephone 914 having speech recognition functionality, may retrieve audio content through the mobile telephone 914, by accessing the voice portal 900 through the Internet 916. Alternatively, a user with a WAP-enabled telephone 918 without speech recognition functionality, along with ordinary mobile and non-mobile telephones 920, may access the voice portal 900 through a public switch telephone network 912 over conventional wireless methods utilizing towers 922a or 922b or wired methods, respectively.

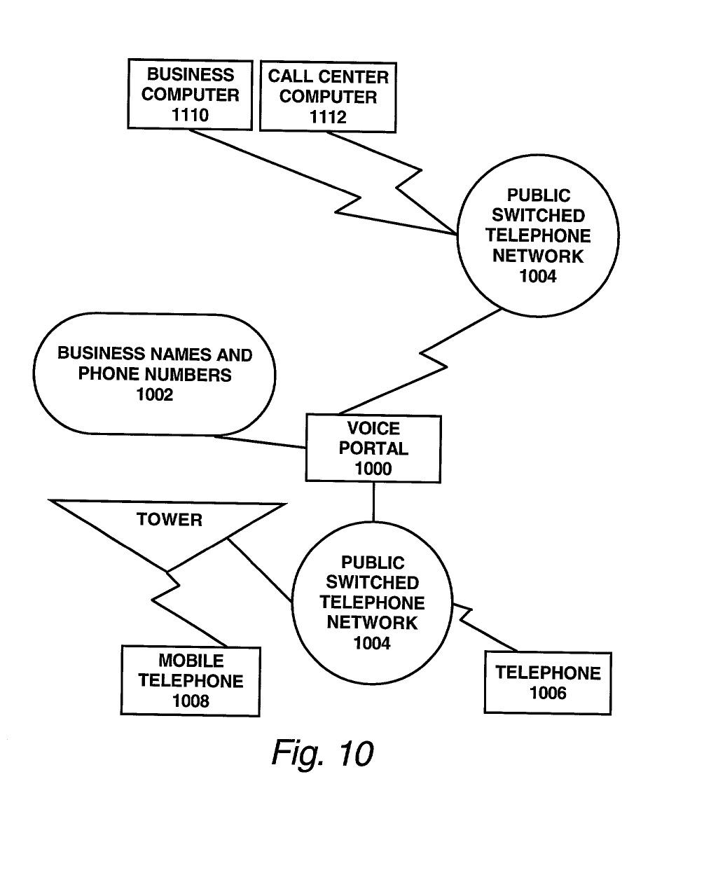

FIG. 10 illustrates another embodiment of a voice portal with the added functionality of access of partnered businesses. In particular, a voice portal 1000. The voice portal 1000 may be configured similarly as the voice portal 100, shown in FIGS. 1-8, as described herein above. The voice portal 1002 further includes a partnered business database 1002. The partnered business database 1002 may be configured to provide storage and access to the names and numbers of the business that have partnered with the service providers of the voice portal 100, i.e., partnered business.

A user accessing the voice portal 1000, may vocalize a request for the audio interface of the voice portal 1000 to replay a list of businesses partnered with the voice portal 1000. The user may vocalize a request to select one of the businesses from the list once connected with the voice portal 1000 with a telephone 1006 or mobile telephone 1008 through the PSTN 1004. The controller 230 of the voice portal may be further configured to connect the user with the selected business 1110 or its agent, a call center computer 112, over the PSTN 1004 in response to verification of the selection. Alternatively, the audio interface may function as a directory and provide a telephone number of the selected business with an audio cue through the audio interface in response to verification of the selection from the partnered business database 1002. Accordingly, a user may obtain toll-free or PSTN number access to a partnered business through the voice portal 1000.

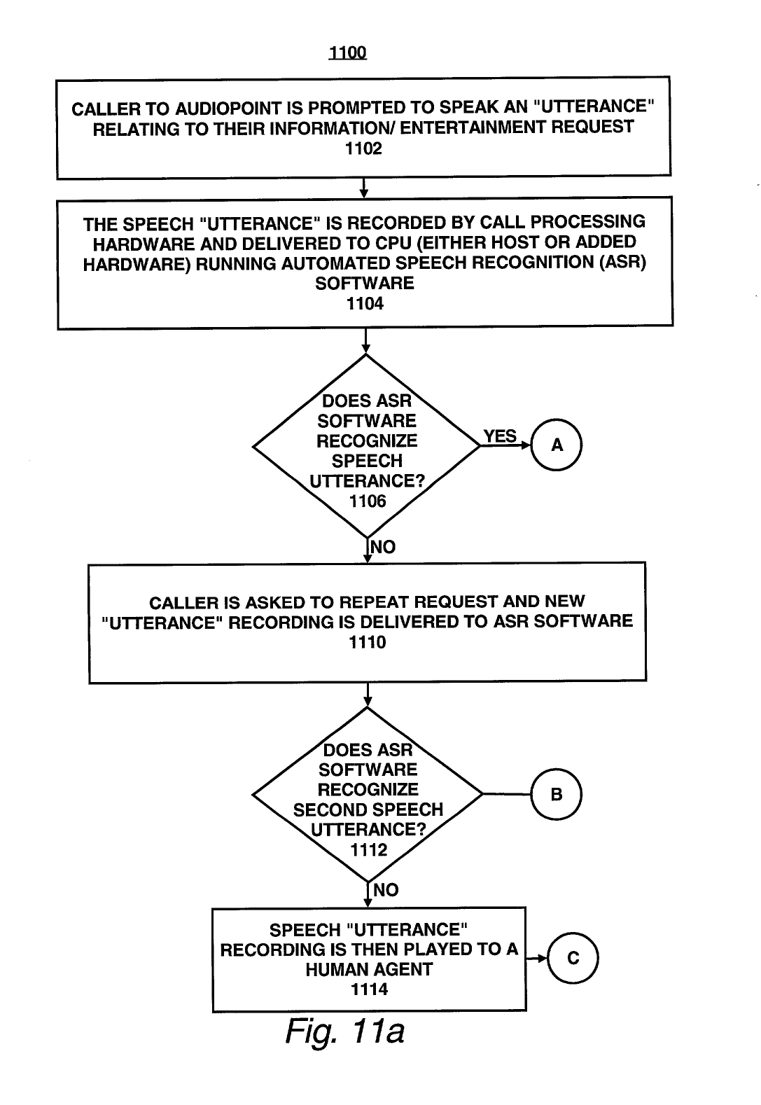

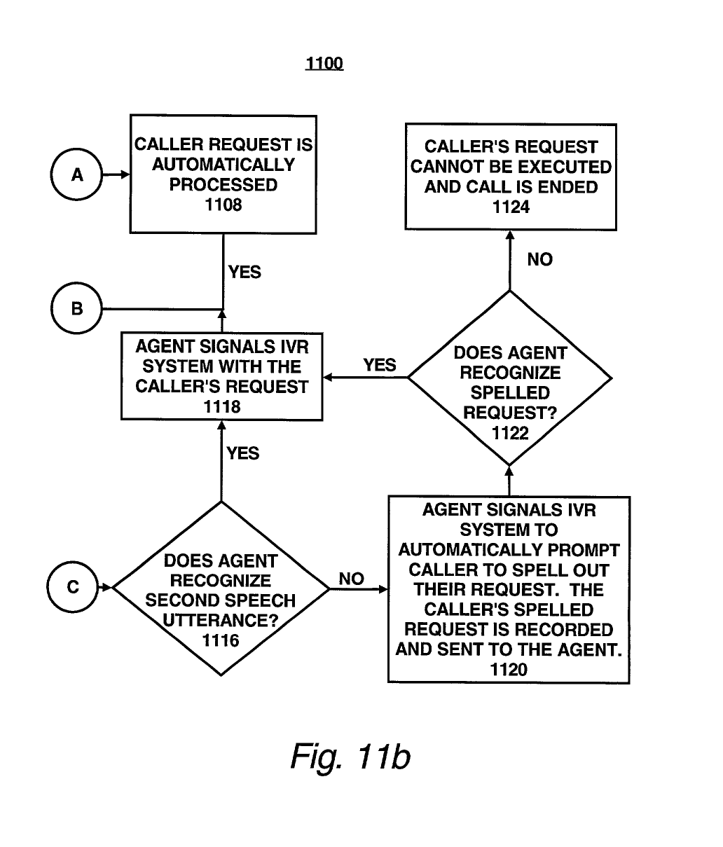

FIGS. 11a-11b illustrate a flow diagram of attendant support of automated speech recognition function of the audio interface of the voice portal according to the principles of the present invention. In particular with reference to FIG. 11a, a user or caller into the voice portal 100 is prompted by the audio interface to vocalize a request, in step 1102. The VRU 220 of the voice portal 100 speech processes the request, in step 1104.

If the VRU 220 of the voice portal 100 speech processes a valid speech data value from step 1106, the user's request is automatically processed, in step 1108 of FIG. 11b, as discussed herein above. Otherwise, if the VRU 220 can not speech process the request, the controller 230 directs the audio interface of the voice portal 100 to prompt the user with an audio cue to repeat the previous request, in step 1110.

If the VRU 220 of the voice portal 100 speech processes the repeated request as a valid speech data value, in step 1112, the user's request is automatically processed, in step 1108 of FIG. 11b, as described herein above. Otherwise, the repeated request is replayed to an attendant or operator of the voice portal 100, in step 1114.

With reference to FIG. 11b, if the attendant identifies the repeated request, in step 1116, the attendant notifies the audio interface of the voice portal 100 the identified request, in step 1118. The notification may be conducted through a touch screen identifying all the possible choices of the voice portal 100, a message to the voice portal 100, etc., as known to those of ordinary skill in the art.

Otherwise, if the attendant cannot identify the repeated request or phrase, the attendant notifies the voice portal to prompt the user to spell out the request, in step 1120. The user spelling out of the request is also recorded and sent to the attendant, in step 1120.

If the attendant identifies the spelled out request, in step 1122, the attendant notifies the audio interface of the voice portal 100 the spelled out request, as in step 1118. Otherwise, the user's request cannot be executed and the call is terminated, in step 1124.

While the invention has been described with reference to the exemplary embodiments thereof, those skilled in the art will be able to make various modifications to the described embodiments of the invention without departing from the true spirit and scope of the invention.

What is claimed is:

1. A method of delivering audio content to a user, said method comprising:
requesting an audio query by said user over a telephone;
translating said audio query into a database query for requesting said audio content from an audio content provider; and
transmitting an audio response of said database query to said user over said telephone.

2. The method of delivering audio content to a user according to claim 2, further comprising:
providing said user a plurality of audio queries; and
recognizing said audio query in response to a selection of said audio query from said plurality of audio queries.

3. The method of delivering audio content to a user according to claim 3, further comprising:
retrieving said audio response in response to said database query.

4. The method of delivering audio content to a user according to claim 4, further comprising:
accessing said audio content provider over a public switched telephone network.

5. The method of delivering audio content to a user according to claim 1, further comprising:
providing a sponsorship message to said user over said telephone in response to said audio query; and
requesting consumer data from said user.

6. The method of delivering audio content to a user according to claim 1, further comprising:
providing a sponsorship message to said user over said telephone in response to said audio query; and
providing a link to said user, said link configured to provide additional information of a sponsor of said sponsorship message.

7. The method of delivering audio content to a user according to claim 1, further comprising:
providing a sponsorship message to said user over said telephone in response to said audio query; and
providing an option for said user to access a live operator.

8. The method of delivering audio content to a user according to claim 1, further comprising:
providing a plurality of menu selections, each menu selection of said plurality of menu selections configured to represent a link to a corresponding audio content; and
navigating said plurality of menu selections in response to a vocal selection of one of said plurality of menu selections.

9. The method of delivering audio content to a user according to claim 8, further comprising:
storing said vocal response; and
retrieving said audio content from said audio content provider in response to said vocal response.

10. A method of delivering audio content to a user, said method comprising:
receiving a vocal request at an audio interface of an audio content provider from said user, said audio interface configured to convert said vocal request into an electronic query;
retrieving a requested audio content from said audio content provider by said audio interface in response to said electronic query; and
outputting said requested audio content by said audio interface, wherein said audio interface is further configured to output said requested audio content to said user over a public switched telephone network.

11. A method of browsing a network, said method comprising:
receiving a vocal browsing request at an audio interface of a content provider from a user;
converting said vocal browsing request to a text browsing request by said audio interface;
searching said network by a wireless application interface configured to search said network according to said text browsing request; and
outputting by said audio interface at least one search result from said wireless application interface in response to said text browsing request.

12. A voice portal for delivering on-demand audio content to a user, said voice portal comprising:
a telco interface configured to interface a network;
a content transformer configured to provide retrieval of information to said telco interface; and
an audio interface configured to speech process a vocal request received through said teleco interface from said user over said network to retrieve a request for audio content from said content transformer.

13. The voice portal for delivering on-demand audio content to a user according to claim 12, wherein said telco interface further comprising:
a voice recognition unit configured to apply speech recognition techniques on said vocal request and further configured to output a corresponding speech data value of said vocal request;
a content transformer interface configured to provide an interface between said content transformer and said telco interface; and
a controller configured to packetize said corresponding speech data for transmission to said content transformer through said content transformer interface.

14. The voice portal for delivering on-demand audio content to a user according to claim 13, wherein said content transformer comprising:
a database configured to provide storage and access to content maintained by said voice portal; and
a content transformer controller configured to retrieve audio content from said database and to transmit said audio content to said telco interface in response to receiving of said corresponding speech data from said telco interface.

15. The voice portal for delivering on-demand audio content to a user according to claim 14, wherein said content transformer further comprising:
a content provider interface configured to receive content provider information from a content provider, wherein said content transformer controller is further configured to store said received content provider information to said database.

16. The voice portal for delivering on-demand audio content to a user according to claim 15, wherein said content transformer interfaces includes a T1 line.

17. The voice portal for delivering on-demand audio content to a user according to claim 13, wherein said content provider information at least one of a news information, a sports information, a financial information, a flight information, a weather information, and a business information.

18. The voice portal for delivering on-demand audio content to a user according to claim 13, wherein said audio interface is configured to provide for a standby attendant to process vocal requests that said voice recognition unit cannot output said corresponding data value for said vocal request.

19. The voice portal for delivering on-demand audio content to a user according to claim 13, further comprising:
an advertising engine configured to provide sponsor messages to said audio interface;
a subscriber profile configured to provide pre-selected audio content to said audio interface, wherein said audio interface is further configured to provide a relevant sponsor message according to said subscriber profile.

20. The voice portal for delivering on-demand audio content to a user according to claim 19, wherein:
said subscriber profile is created by tracking usage patterns of said user.

21. The voice portal for delivering on-demand audio content to a user according to claim 19, wherein:
said subscriber profile is created through a web site of said voice portal.

22. The voice portal for delivering on-demand audio content to a user according to claim 12, wherein said voice recognition unit is further configured to provide speech synthesis on text data received from said content transformer.

23. The voice portal for delivering on-demand audio content to a user according to claim 12, wherein said telco interface includes a T1 interface configured to interface said telco interface with said network.

24. The voice portal for delivering on-demand audio content to a user according to claim 12, wherein said audio interface is configured to provide a connection to a partnered business in response to a request for said partnered business.

25. A voice portal for delivering on-demand audio content to a user, said voice portal comprising:
a wireless application interface configured to interface a wireless network;
a content transformer configured to provide retrieval of information to said wireless application interface; and
a wireless application server configured to process a request received through said wireless application interface from a mobile user over said wireless network to retrieve a request for audio content from said content transformer.

26. The voice portal for delivering on-demand audio content to a user according to claim 25, wherein said wireless application interface substantially conforming to a wireless data protocol.

27. The voice portal for delivering on-demand audio content to a user according to claim 26, wherein said wireless data protocol includes a wireless application protocol.

28. A voice portal for delivering on-demand audio content to a user, said voice portal comprising:
a telco interface configured to interface a network;
a wireless application interface configured to interface a wireless network;
a content transformer configured to provide retrieval of information from both said telco interface and said wireless application interface; and
a wireless application server configured to process a request for audio content received through one of said telco interface and said wireless application interface to retrieve said request for audio content from said content.

29. A voice portal for delivering on-demand audio content to a user, said voice portal comprising:
a telco interface configured to interface a network;
a wireless application interface configured to interface a wireless network;
a content transformer configured to provide retrieval of information from both said telco interface and said wireless application interface; and
a wireless application server configured to process a request for audio content received through one of said telco interface and said wireless application interface to retrieve said request for audio content from said content transformer and to transmit retrieved audio content to the other of said telco interface and said wireless application interface.
